(19) United States
(12) Patent Application Publication
(10) Pub. No.: US 2023/0329312 A1
(43) Pub. Date: Oct. 19, 2023

(54) METHODS FOR MANUFACTURING FOOD SHAPING MOLD AND FOOD, AND FOOD SHAPING MOLD

(71) Applicant: FIVEGRAND INTERNATIONAL CO., LTD., New Taipei City (TW)

(72) Inventor: TING-JUI WANG, New Taipei City (TW)

(21) Appl. No.: 18/133,548

(22) Filed: Apr. 12, 2023

(30) Foreign Application Priority Data
Apr. 14, 2022 (TW) 111114185

(51) Int. Cl. A23P 30/10; A21C 9/06; G06Q 50/04; G06Q 30/0201; B29C 64/386; B33Y 50/00; B33Y 99/00; B33Y 80/00

(52) U.S. Cl. CPC A23P 30/10; A21C 9/06; G06Q 50/04; G06Q 30/0201; B29C 64/386; B33Y 50/00; B33Y 99/00; B33Y 80/00; B29L 2031/757

(57) ABSTRACT

A method for manufacturing a food shaping mold includes following steps. A calculation module is provided. The calculation module calculates a shape or form of a corresponding food shaping mold according to a target shape of a target food, or calculates the shape or form of a corresponding food shaping mold according to a target density, thickness, hardness, elasticity, tasting texture, glutenness, taste, color, temperature, structure, shape or flavor of the target food so as to produce a food shaping mold. The present disclosure further provides a food shaping mold, which is manufactured by the above method. The present disclosure further provides a method for manufacturing a food, wherein the shape, form or structure of the target food is calculated by the above method for manufacturing a food shaping mold.

### CROSS-REFERENCE TO RELATED APPLICATION

This non-provisional application claims priority under 35 U.S.C. § 119(a) on Patent Application No(s). 111114185 filed in Taiwan, R.O.C. on Apr. 14, 2022, the entire contents of which are hereby incorporated by reference.

### BACKGROUND OF THE INVENTION

### 1. Field of the Invention

The present disclosure provides methods for manufacturing a food shaping mold and a food, and a food shaping mold, and in particular to a food shaping mold and a food designed according to a shape, structure density, a thickness or elasticity of a target food, and a manufacturing method thereof.

### 2. Description of the Related Art

Foods with fillings have different tasting textures on the inside and the outside in terms of softness, and fillings in diversified flavors are also deeply loved by people. The operation of filling is conventionally performed manually. Accompanied with industrialization, foods with fillings added by machines have become available. However, in response to a shape and softness of different foods, differently shaped molds and mold cores with different levels of softness are also needed. Development of new molds frequently involves lengthy periods, which may delay the time-to-market of such new foods.

### BRIEF SUMMARY OF THE INVENTION

With extensive research and development, the applicant has provided methods for manufacturing a food shaping mold and a food, and a food shaping mold, in the aim of quickly developing a food shaping mold to thereby speed up the time-to-market of a target food.

To achieve the above and other objects, a method for manufacturing a food shaping mold provided according to a first aspect of the present disclosure includes the following step. A calculation module (or a calculation scheme) is provided. The calculation module (or the calculation scheme) calculates a shape or form of a corresponding food shaping mold according to a target shape of a target food so as to produce the food shaping mold.

To achieve the above and other objects, a method for manufacturing a food shaping mold provided according to a second aspect of the present disclosure includes the following step. A calculation module (or a calculation scheme) is provided. The calculation module (or the calculation scheme) calculates a shape or form of a corresponding food shaping mold according to a target density, hardness, thickness, elasticity, tasting texture, glutenness, taste, color, temperature, structure, shape or flavor of a target food so as to produce the food shaping mold.

To achieve the above and other objects, a method for manufacturing a food shaping mold provided according to a third aspect of the present disclosure includes the following step. A calculation module (or a calculation scheme) is provided. The calculation module (or the calculation scheme) calculates a shape or form of a corresponding food shaping mold according to a density, thickness, hardness, elasticity, tasting texture, glutenness, taste, color, temperature, structure, shape or flavor of a target region of a target food so as to produce the food shaping mold.

To achieve the above and other objects, a method for manufacturing a food shaping mold provided according to a fourth aspect of the present disclosure includes the following step. A calculation module (or a calculation scheme) is provided. The calculation module (or the calculation scheme) calculates a material or structure of a corresponding food shaping mold according to a target shape of a target food so as to produce the food shaping mold.

To achieve the above and other objects, a method for manufacturing a food shaping mold provided according to a fifth aspect of the present disclosure includes the following step. A calculation module (or a calculation scheme) is provided. The calculation module (or the calculation scheme) calculates a material or structure of a corresponding food shaping mold according to a target density, thickness, hardness, elasticity, tasting texture, glutenness, taste, color, temperature, structure, shape or flavor of a target food so as to produce the food shaping mold.

To achieve the above and other objects, a method for manufacturing a food shaping mold provided according to a sixth aspect of the present disclosure includes the following step. A calculation module (or a calculation scheme) is provided. The calculation module (or the calculation scheme) calculates a material of a corresponding food shaping mold according to a density, hardness, thickness, elasticity, tasting texture, glutenness, taste, color, temperature, structure, shape or flavor of a target region of a target food so as to produce the food shaping mold.

To achieve the above and other objects, a food shaping mold provided according to a seventh aspect of the present disclosure is manufactured by the method for manufacturing a food shaping mold according to one of the first to sixth aspects. The food shaping mold includes a soft mold body. The soft mold body is used to apply a different or the same pressure on a different or the same position of the target food, so that the target food has different densities, thicknesses, hardness, elasticity, tasting textures, glutenness, colors, temperatures, tastes, structures, shapes or flavors at different positions.

To achieve the above and other objects, a food shaping mold provided according to an eighth aspect of the present disclosure is manufactured by the method for manufacturing a food shaping mold according to one of the first to sixth aspects. The food shaping mold includes a mold body. The mold body is used to apply a different or the same pressure on a different or the same position of the target food, so that the target food has different densities, thicknesses, hardness, elasticity, tasting textures, glutenness, colors, temperatures, tastes, structures, shapes or flavors at different positions.

To achieve the above and other objects, a food shaping mold provided according to a ninth aspect of the present disclosure is manufactured by the method for manufacturing a food shaping mold according to one of the first to sixth aspects. The food shaping mold includes a soft mold body. The mold body is used to apply a different or the same pressure on the target food, so that the target food has different or the same density, thickness, hardness, elasticity, glutenness, tasting texture, color, temperature, taste, structure, shape or flavor.

To achieve the above and other objects, a food shaping mold provided according to a tenth aspect of the present disclosure is manufactured by the method for manufacturing a food shaping mold according to one of the first to sixth aspects. The food shaping mold includes a mold body. The mold body is used to apply a different or the same pressure on the target food, so that the target food has different or the same density, thickness, hardness, elasticity, glutenness, tasting texture, color, temperature, taste, structure, shape or flavor.

To achieve the above and other objects, a food shaping mold provided according to an eleventh aspect of the present disclosure is manufactured by the method for manufacturing a food shaping mold according to one of the first to sixth aspects. The food shaping mold includes a soft mold body. The mold body is used to apply a different or the same pressure on, add an ingredient to, or control a temperature of the target food, so that the target food has different or the same density, thickness, hardness, elasticity, glutenness, tasting texture, color, temperature, taste, structure, shape or flavor.

To achieve the above and other objects, a food shaping mold provided according to a twelfth aspect of the present disclosure is manufactured by the method for manufacturing a food shaping mold according to one of the first to sixth aspects. The food shaping mold includes a mold body. The mold body is used to apply a different or the same pressure on, add an ingredient to, or control a temperature of the target food, so that the target food has different or the same density, thickness, hardness, elasticity, glutenness, tasting texture, color, temperature, taste, structure, shape or flavor.

To achieve the above and other objects, a method for manufacturing a food provided according to a thirteenth aspect of the present disclosure calculates the shape, form or structure of the target food by the above method for manufacturing a food shaping mold.

With the methods for manufacturing a food shaping mold and a food, a food shaping mold of a target food can be quickly designed to thereby speed up the time-to-market of a target food.

### BRIEF DESCRIPTION OF THE DRAWINGS

FIG. 1 is a flowchart of a method for manufacturing a food shaping mold according to a specific embodiment of the present disclosure.

FIG. 2 is a block schematic diagram of a manufacturing system of the food shaping mold corresponding to FIG. 1.

FIG. 3 is a first schematic diagram of operations of manufacturing a target food by using a food shaping mold according to a specific embodiment of the present disclosure.

FIG. 4 is a schematic diagram of an operation for filling a target food to one side of a food shaping mold according to a specific embodiment of the present disclosure.

FIG. 5 is a second schematic diagram of operations of manufacturing a target food by using a food shaping mold according to a specific embodiment of the present disclosure.

FIG. 6 is a first diagram of a target food manufactured by using a food shaping mold of the present disclosure.

FIG. 7 is a second diagram of a target food manufactured by using a food shaping mold of the present disclosure.

FIG. 8 is a third diagram of a target food manufactured by using a food shaping mold of the present disclosure.

FIG. 9 is a fourth diagram of a target food manufactured by using a food shaping mold of the present disclosure.

FIG. 10 is a perspective schematic diagram of an electronic device for performing a method for manufacturing a food shaping mold according to a specific embodiment of the present disclosure.

FIG. 11 is an operation flowchart of a sales analysis module in FIG. 2.

### DETAILED DESCRIPTION OF THE INVENTION

To facilitate understanding of the object, characteristics and effects of this present disclosure, embodiments together with the attached drawings for the detailed description of the present disclosure are provided.

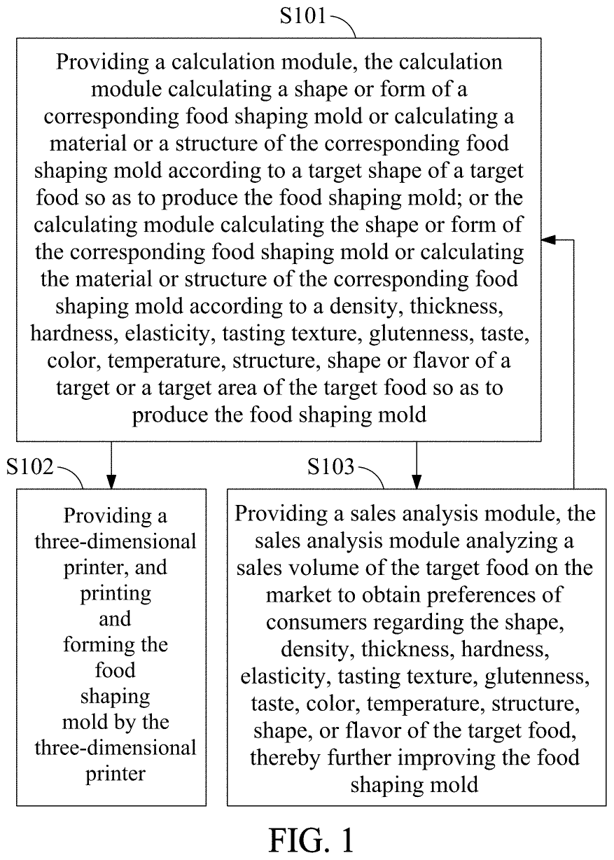

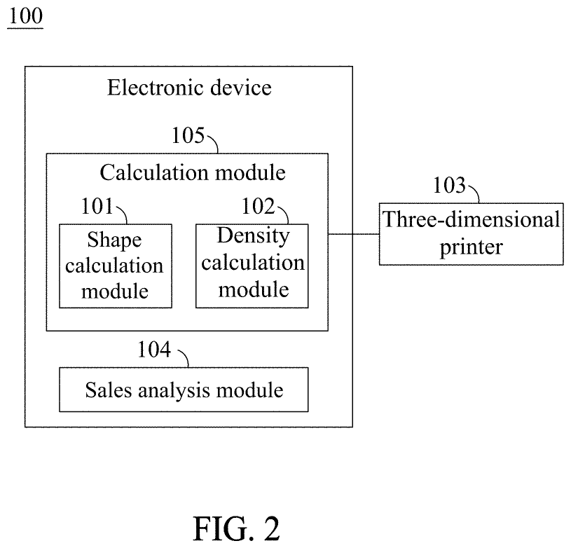

Referring to FIG. 1 to FIG. 5, a method for manufacturing a food shaping mold provided according to a first aspect of the present disclosure includes step S101 of providing a calculation module 105 (or a calculation scheme). The calculation module 105 (or the calculation scheme) calculates a shape or form of a corresponding food shaping mold 3 according to a target shape of a target food 2 so as to produce the food shaping mold 3. As shown in FIG. 2, the calculation module 105 is software and may include a shape calculation module 101 to perform the above step.

Referring to FIG. 1 to FIG. 5, a method for manufacturing a food shaping mold provided according to a second aspect of the present disclosure includes step S101 of providing a calculation module 105 (or a calculation scheme). The calculation module 105 (or the calculation scheme) calculates a shape or form of a corresponding food shaping mold 3 according to a target density, thickness, hardness, elasticity, tasting texture, glutenness, taste, color, temperature, structure, shape or flavor of the target food 2 so as to produce the food shaping mold 3. As shown in FIG. 2, the calculation module 105 is software and may include a density calculation module 102 to perform the above step.

Referring to FIG. 1 to FIG. 5, a method for manufacturing a food shaping mold provided according to a third aspect of the present disclosure includes step S101 of providing a calculation module 105 (or a calculation scheme). The calculation module 105 (or the calculation scheme) calculates a shape or form of a corresponding food shaping mold 3 according to a density, thickness, hardness, elasticity, tasting texture, glutenness, taste, color, structure, shape or flavor of a target region 20 of the target food 2 so as to produce the food shaping mold 3. As shown in FIG. 2, the calculation module 105 is software and may include a density calculation module 102 to perform the above step.

Referring to FIG. 1 to FIG. 5, a method for manufacturing a food shaping mold provided according to a fourth aspect of the present disclosure includes step S101 of providing a calculation module 105 (or a calculation scheme). The calculation module 105 (or the calculation scheme) calculates a material or structure of a corresponding food shaping mold 3 according to a target shape of a target food 2 so as to produce the food shaping mold 3. As shown in FIG. 2, the calculation module 105 is software and may include a shape calculation module 101 to perform the above step.

Referring to FIG. 1 to FIG. 5, a method for manufacturing a food shaping mold provided according to a fifth aspect of the present disclosure includes step S102 of providing a calculation module 105 (or a calculation scheme). The calculation module 105 (or the calculation scheme) calculates a material or structure of a corresponding food shaping mold 3 according to a target density, thickness, hardness, elasticity, tasting texture, taste, color, structure, shape, glutenness or flavor of a target food 2 so as to produce the food shaping mold 3. As shown in FIG. 2, the calculation module 105 is software and may include a density calculation module 102 to perform the above step.

Referring to FIG. 1 to FIG. 5, a method for manufacturing a food shaping mold provided according to a sixth aspect of the present disclosure includes step S102 of providing a calculation module 105 (or a calculation scheme). The calculation module 105 (or the calculation scheme) calculates a material or structure of a corresponding food shaping mold 3 according to a structural density, thickness, hardness, elasticity, tasting texture, taste, color, structure, shape, glutenness or flavor of the structure of a target region 20 of a target food 2 so as to produce the food shaping mold 3. As shown in FIG. 2, the calculation module 105 is software and may include a density calculation module 102 to perform the above step.

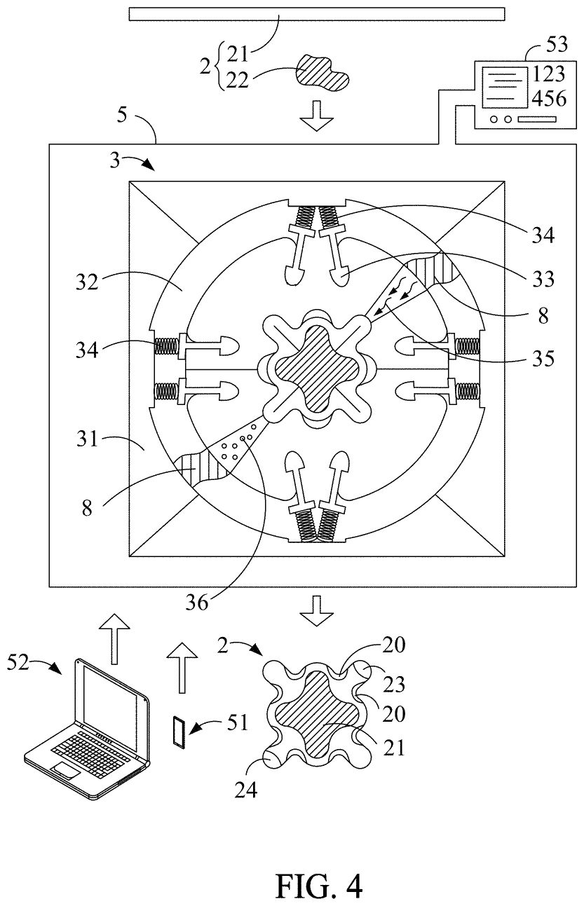

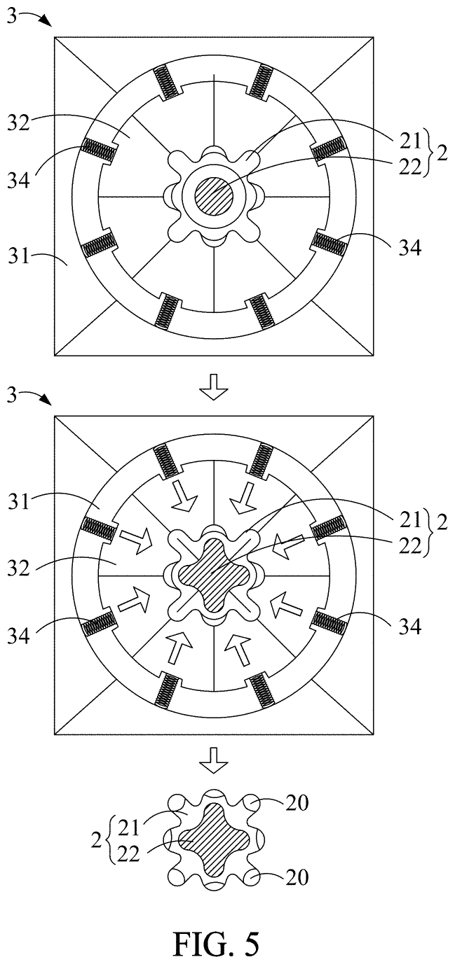

Referring to FIG. 4 and FIG. 5, a food shaping mold 3 provided according to a seventh aspect of the present disclosure is manufactured by the method for manufacturing a food shaping mold according to one of the first to sixth aspects. The food shaping mold 3 includes a soft mold body 30. The soft mold body 30 is used to apply a different or the same pressure on a different or the same position of the target food 2, so that the target food 2 has different densities, thicknesses, hardness, elasticity, tasting textures, colors, glutenness, tastes, structures, shapes or flavors at different positions.

Referring to FIG. 4 and FIG. 5, a food shaping mold 3 provided according to an eighth aspect of the present disclosure is manufactured by the method for manufacturing a food shaping mold according to one of the first to sixth aspects. The food shaping mold 3 includes a mold body 30. The soft mold body 30 is used to apply a different or the same pressure on a different or the same position of the target food 2, so that the target food 2 has different densities, thicknesses, hardness, elasticity, tasting textures, glutenness, colors, tastes, structures, shapes or flavors at different positions.

Referring to FIG. 4 and FIG. 5, a food shaping mold 3 provided according to a ninth aspect of the present disclosure is manufactured by the method for manufacturing a food shaping mold according to one of the first to sixth aspects. The food shaping mold 3 includes a soft mold body 30. The mold body 30 is used to apply a different or the same pressure on the target food 2, so that the target food 2 has different or the same density, thickness, hardness, elasticity, glutenness, tasting texture, color, temperature, taste, structure, shape or flavor.

Referring to FIG. 4 and FIG. 5, a food shaping mold 3 provided according to a tenth aspect of the present disclosure is manufactured by the method for manufacturing a food shaping mold according to one of the first to sixth aspects. The food shaping mold 3 includes a mold body 30. The mold body 30 is used to apply a different or the same pressure on the target food 2, so that the target food 2 has different or the same density, thickness, hardness, elasticity, glutenness, tasting texture, color, temperature, taste, structure, shape or flavor.

Referring to FIG. 4 and FIG. 5, a food shaping mold 3 provided according to an eleventh aspect of the present disclosure is manufactured by the method for manufacturing a food shaping mold according to one of the first to sixth aspects. The food shaping mold 3 includes a soft mold body 30. The mold body 30 is used to apply a different or the same pressure on, add an ingredient to, or control a temperature of the target food 2, so that the target food 2 has different or the same density, thickness, hardness, elasticity, glutenness, tasting texture, color, temperature, taste, structure, shape or flavor.

Referring to FIG. 4 and FIG. 5, a food shaping mold 3 provided according to a twelfth aspect of the present disclosure is manufactured by the method for manufacturing a food shaping mold according to one of the first to sixth aspects. The food shaping mold 3 includes a mold body 30. The mold body 30 is used to apply a different or the same pressure on, add an ingredient to, or control a temperature of the target food 2, so that the target food 2 has different or the same density, thickness, hardness, elasticity, glutenness, tasting texture, color, temperature, taste, structure, shape or flavor.

Referring to FIG. 1 to FIG. 5, a method for manufacturing a food provided according to a thirteenth aspect of the present disclosure calculates the shape, form or structure of the target food 2 by the above method for manufacturing a food shaping mold.

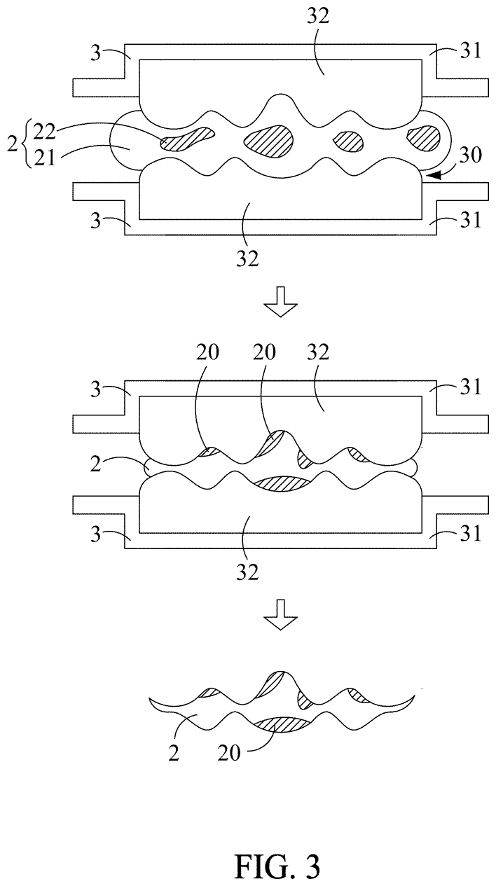

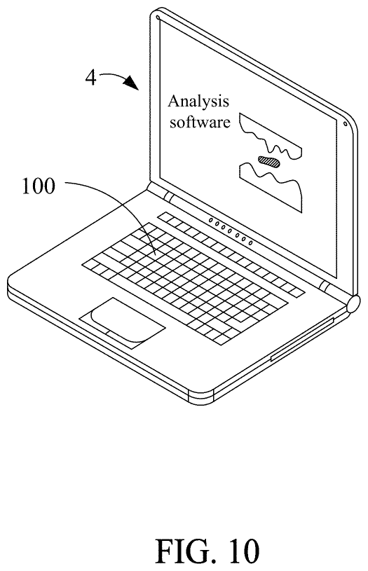

As shown in FIG. 2, the shape calculation module 101 and the density calculation module 102 may each be software, and are included in a manufacturing system 100 for a food shaping mold. The software may be three-dimensional software, two-dimensional software, stress calculation software, elasticity calculation software, pressure calculation software, moisture content calculation software, grease content calculation software, shear calculation software, temperature calculation software, tasting texture calculation software, taste calculation software, flavor calculation software, glutenness calculation software, thickness calculation software, mold flow calculation software, hardness calculation software, subduing force calculation software, density calculation software, structure calculation software or structure planning software. As shown in FIG. 10, the shape calculation module 101 and the density calculation module 102 may each be installed in an electronic device 4. FIG. 10 shows that the electronic device 4 is a laptop computer; however, the present disclosure is not limited to the above example, and the electronic device 4 may also be a personal computer, server, workstation or mobile device. Also referring to FIG. 3 to FIG. 5, more specifically, the material of the target food 2, or the material densities, thicknesses, glutenness, hardness, elasticity, tasting textures, colors, temperatures, tastes or flavors of materials of different ingredients in the target food 2 are obtained, measured or calculated in form of numerical values as physical numerical values. The numerical values are input to the modules of the above software to calculate the shape or form of the food shaping mold 3 corresponding to the target shape or target structure of the target food 2 or the corresponding food, so as to produce the shape, form or structure of the food shaping mold 3 or the corresponding target food 2. Alternatively, the numerical values are used to calculate the shape or form of the food shaping mold 3 corresponding to the target shape or target structure of the target food 2 or the corresponding target food 2, so that the target food 2 has different densities, thicknesses, glutenness, hardness, elasticity, tasting textures, colors, temperatures, structures, shapes, tastes or flavors, so as to produce the shape, form or structure of the food shaping mold 3 or the corresponding target food 2. Alternatively, the numerical values are used to calculate the shape or form of the food shaping mold 3 corresponding to predetermined targets of different densities, thicknesses, glutenness, hardness, elasticity, tasting textures, colors, temperatures, structures, shapes, tastes or flavors at different positions of the target food 2 or the corresponding target food 2, so as to produce the shape, form or structure of the food shaping mold 3 or the corresponding target food 2.

Alternatively, the numerical values are used to calculate the shape or form of the food shaping mold 3 corresponding to a predetermined target of the target food 2 or the corresponding target food 2, so as to produce the shape, form or structure of the food shaping mold 3 or the corresponding target food 2. Alternatively, the numerical values are used to calculate the shape or form of the food shaping mold 3 corresponding to a predetermined target of the target food 2 or the corresponding target food 2, so as to produce the shape, form or structure of the food shaping mold 3 or the corresponding target food 2. Alternatively, the numerical values are used to calculate the shape or form of the food shaping mold 3 corresponding to a target of the target food 2 or the corresponding target food 2, so as to produce the shape, form or structure of the food shaping mold 3 or the corresponding target food 2.

As described above, with the methods for manufacturing a food shaping mold and a food, a food shaping mold of the target food 2 can be quickly designed to thereby speed up the time-to-market of the target food 2.

As shown in FIG. 4 and FIG. 5, in one embodiment, the target food 2 has a skin layer 21 and a filling 22 wrapped in the skin layer 21. A different skin layer 21 or filling 22 has a different density, thickness, hardness, elasticity, tasting texture, glutenness, color, temperature, structure, shape, taste or flavor. During the manufacturing of the target food 2, ingredients or flavoring agents needed to be added to the target food 2 may be added to the skin layer 21 or the filling 22. The target food 2 may be a food with a tasting texture, including dumplings, buns, balls, cookies, noodles, ice products, cakes, ice cream cakes, ice cream bars, ice popsicles, ice creams, rice cakes and wraps. The food shaping mold 3 is a soft body or a hard body, and is used to provide the skin layer 21 or different regions of the skin layer 21 with different densities, thicknesses, hardness, elasticity, tasting textures, glutenness, colors, temperatures, structures, shapes, tastes or flavors. Similarly, the food shaping mold 3 is used to provide the filling 22 or different regions of the filling 22 with different densities, thicknesses, hardness, elasticity, tasting textures, glutenness, colors, temperatures, structures, shapes, tastes or flavors. The target region 20 may be a high density region, while remaining regions may be low density regions. The food shaping mold 3 may be consisted of a plurality of components, and may include a mold base 31 and two mold cores 32 arranged in the mold base 31. The mold base 31 may be a fixed structure, and each mold core 32 may be a structure mobile relative to the mold core 32 or a replaceable structure. The food shaping mold 3 may further be provided with a pressurizing body 33 or an elastic element 34, or may be provided with both the pressurizing body 33 and the elastic element 34. In FIG. 4, the elastic element 34 may be a coil spring, which has two ends pressing against the mold base 31 and the pressurizing body 33, so as to apply an elastic force upon the target food 2 through the pressurizing body 33. In FIG. 5, the food shaping mold 3 is not provided with the pressurizing body 33 in FIG. 4, and two ends of the elastic elements 34 directly press against the mold cores 32 and the mold base 31. When the food shaping mold 3 presses and shapes the target food 2, the pressurizing body 33 may pressurize a plurality of target regions 20 of the target food 2 (for example, an action of pressing and sealing a dough piece when making a dumpling or bun), so that the different regions of the target food 2 have different densities, thicknesses, hardness, elasticity, tasting textures, glutenness, tastes or flavors. The food shaping mold 3 may have a soft part at the mold cores 32. The soft part may be made of glue, silicone, ester, a natural material, an environmentally friendly material, wood, metal, rubber or plastic. FIG. 4 and FIG. 5 respectively show pressurizing structures of different configurations (for example, the pressurizing body 33 or the pressurizing body 33 and the elastic element 34), so that the shaped target food 2 has different shapes or forms. More specifically, the food shaping mold 3 may pressurize the target food 2 once, multiple times or in stages, so that the target food 2 has different densities, thicknesses, hardness, elasticity, tasting textures, glutenness, colors, temperatures, structures, shapes, tastes or flavors at different positions.

As shown in FIG. 4 and FIG. 5, the food shaping mold 3 manufactured by the method for manufacturing a food shaping mold is applicable to automated equipment (for example, food manufacturing equipment 5) so as to automatically produce the target food 2. Alternatively, the food shaping mold 3 is applicable to semi-automated equipment (for example, food manufacturing equipment 5) so as to semi-automatically produce the target food 2. Alternatively, the food shaping mold 3 is applied to manual operations so as to manually produce the target food 2. In one embodiment, the food manufacturing equipment 5 coordinating with the food shaping mold 3 is remotely controlled or has a program setting interface 53 to set manufacturing parameters or pressurization parameters of the food shaping mold 3, so that the target food 2 has different or the same density, thickness, hardness, elasticity, glutenness, tasting texture, color, temperature, taste, structure, shape or flavor. A cellphone 51, a laptop computer 52 or other electronic devices may be used to remotely control the food manufacturing equipment 5. The mold 3 may include a temperature control mold passage 35 that controls a temperature change during the manufacturing of the target food 2. The mold 3 may include a material feeding mold passage 36 for material feeding during the manufacturing of the target food 2. The temperature control mold passage 35 and the material feeding mold passage 36 are individually in communication with the target food 2. The temperature control mold passage 35 and the material feeding mold passage 36 are further individually connected to a pipeline 8, so as to be respectively in communication with material feeding equipment (not shown) and temperature control equipment (not shown). Thus, the prepared target food 2 has a temperature change region 23 and an ingredient adding region 24. The food shaping mold 3 may be provided with both the temperature control mold passage 35 and the material feeding mold passage 36, or may be provided with either of the two, depending on requirements.

As shown in FIG. 1 and FIG. 2 and also with reference to FIG. 3, in one embodiment, the method for manufacturing the food shaping mold 3 of the present disclosure may further include step S103 of providing a three-dimensional printer 103, and printing and forming the food shaping mold 3 by the three-dimensional printer 103. Thus, the food shaping mold 3 can be quickly manufactured.

As shown in FIG. 1 and FIG. 2 and also referring to FIG. 3, in one embodiment, the method for manufacturing the food shaping mold 3 of the present disclosure may further include step S103 of providing a sales analysis module 104. The sales analysis module 104 analyzes the sales volume of the target food 2 on the market so as to obtain preferences of consumers regarding the shape, density, thickness, hardness, elasticity, tasting texture, glutenness, color, temperature, structure, shape, taste or flavor of the target food, thereby further improving the food shaping mold 3. The sales analysis module may be provided with artificial intelligence so as to achieve the above analysis by using algorithms. The sales analysis module 104 is similarly software installed in the electronic device 4.

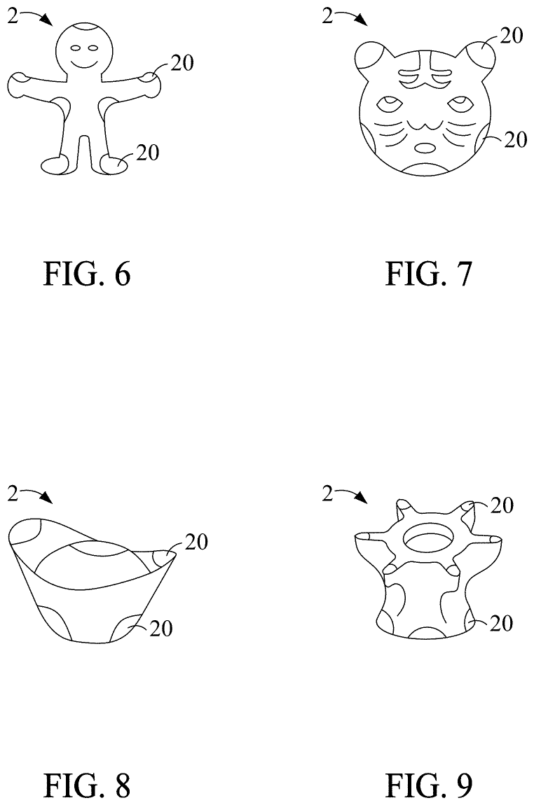

As shown in FIG. 6 to FIG. 9 and also referring to FIG. 4 and FIG. 5, the method for manufacturing the food shaping mold 3 imports the development of the target food 2 or the food shaping mold 3 by means of the appearance, structure or technique of the food shaping mold 3 according to authorization of different trademark, patent or intellectual property rights, or imports the development of the target food 2 or the food shaping mold 3 according to appearance or flavor requirements or tasting texture or smell requirements of consumers or buyers. For example, FIG. 6 depicts the target food 2 in a human shape, FIG. 7 depicts the target food 2 in a tiger head shape, FIG. 8 depicts the target food 2 in an ingot shape, and FIG. 9 depicts the target food 2 in a wanton shape. The target food 2 may be heated in the food shaping mold 3, or be shaped in the food shaping mold 3, taken out and then heated, or be heated before being shaped in the food shaping mold. The method for manufacturing the food shaping mold may also calculate appearance or flavor requirements according to big data and accordingly import the development of the target food 2 or the food shaping mold 3. The method for manufacturing the food shaping mold may also import the development of the target food 2 or the food shaping mold 3 according to appearance or flavor requirements of industrialist development or developers.

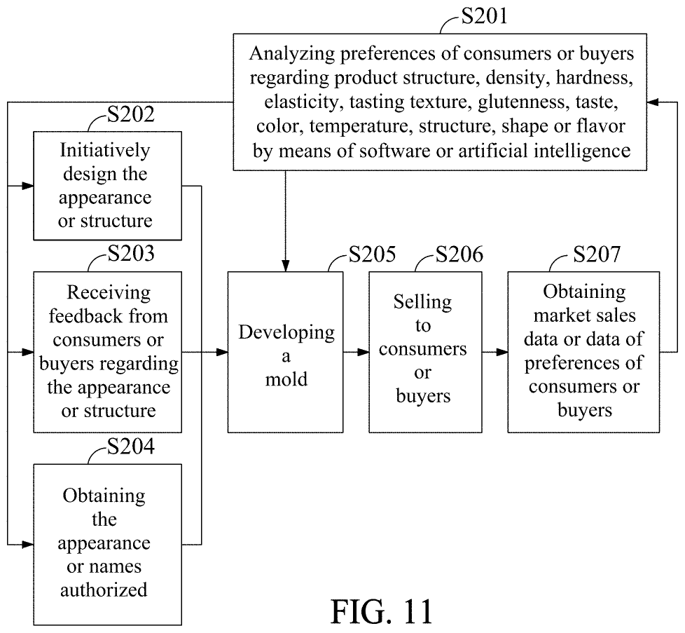

As shown in FIG. 11, in step S201, the sales analysis module 104 in FIG. 2 analyzes preferences of consumers or buyers regarding the product structure, density or elasticity by means software or artificial intelligence. In step S205, mold development is performed according to the initiatively designed appearance or structure, feedback received from consumers or buyers regarding the appearance or structure or results of the appearance or structure authorized in step S202 to step S204. In step S206, a new product is sold to consumers or buyers. In step S207, market sales data or preference data of consumers or buyers is obtained and then fed back to step S201 for preference analysis.

The present invention is described by way of the preferred embodiments above. A person skilled in the art should understand that, these embodiments are merely for describing the present invention are not to be construed as limitations to the scope of the present invention. It should be noted that all equivalent changes, replacements and substitutions made to the embodiments are to be encompassed within the scope of the present invention. Therefore, the scope of protection of the present invention should be accorded with the broadest interpretation of the appended claims.

What is claimed is:

1. A method for manufacturing a food shaping mold, comprising a step of:
providing a calculation module, the calculation module calculating a material, structure, shape or form of a corresponding food shaping mold according to a target density, hardness, elasticity, tasting texture, glutenness, taste, temperature or flavor of a target food so as to produce the food shaping mold.

2. A method for manufacturing a food shaping mold, comprising a step of:
providing a calculation module, the calculation module calculating a material, structure, shape or form of a corresponding food shaping mold according to a density, hardness, elasticity, glutenness, tasting texture, taste, temperature or flavor of a target region of a target food so as to produce the food shaping mold.

3. A food shaping mold, manufactured by the method for manufacturing a food shaping mold of claim 1, the food shaping mold comprising:
a mold body used to apply a different or the same pressure on, add an ingredient to, or control the temperature of the target food, so that the target food has a different or the same density, hardness, elasticity, glutenness, tasting texture, temperature, taste or flavor.

4. A food shaping mold, manufactured by the method for manufacturing a food shaping mold of claim 2, the food shaping mold comprising:
a mold body used to apply a different or the same pressure on, add an ingredient to, or control the temperature of the target food, so that the target food has a different or the same density, hardness, elasticity, glutenness, tasting texture, temperature, taste or flavor.

5. A food shaping mold, comprising:
a mold body used to apply a different or the same pressure on, add an ingredient to, or control a temperature of the target food, so that the target food has a different or the same density, hardness, elasticity, glutenness, tasting texture, temperature, taste or flavor.

6. The food shaping mold of claim 3, wherein the target food has a skin layer and a filling wrapped in the skin layer, the food shaping mold is used to provide the skin layer or different regions of the skin layer with different densities, hardness, glutenness, elasticity, tasting textures, temperatures, tastes or flavors, or the food shaping mold is used to provide the filling or different regions of the filling with different densities, hardness, glutenness, elasticity, tasting textures, temperatures, tastes or flavors.

7. The food shaping mold of claim 4, wherein the target food has a skin layer and a filling wrapped in the skin layer, the food shaping mold is used to provide the skin layer or different regions of the skin layer with different densities, hardness, glutenness, elasticity, tasting textures, temperatures, tastes or flavors, or the food shaping mold is used to provide the filling or different regions of the filling with different densities, hardness, glutenness, elasticity, tasting textures, temperatures, tastes or flavors.

8. The food shaping mold of claim 5, wherein the target food has a skin layer and a filling wrapped in the skin layer, the food shaping mold is used to provide the skin layer or different regions of the skin layer with different densities, hardness, glutenness, elasticity, tasting textures, temperatures, tastes or flavors, or the food shaping mold is used to provide the filling or different regions of the filling with different densities, hardness, glutenness, elasticity, tasting textures, temperatures, tastes or flavors.

9. The food shaping mold of claim 3, comprising a pressurizing body or an elastic element.

10. The food shaping mold of claim 4, comprising a pressurizing body or an elastic element.

11. The food shaping mold of claim 5, comprising a pressurizing body or an elastic element.

12. The method for manufacturing a food shaping mold of claim 1, further comprising a step of:
providing a three-dimensional printer, and printing and forming the food shaping mold by the three-dimensional printer.

13. The method for manufacturing a food shaping mold of claim 2, further comprising a step of:
providing a three-dimensional printer, and printing and forming the food shaping mold by the three-dimensional printer.

14. The method for manufacturing a food shaping mold of claim 1, further comprising a step of:
providing a sales analysis module, the sales analysis module analyzing a sales volume of the target food on a market to obtain preferences of consumers regarding a shape, density, hardness, glutenness, elasticity, tasting texture, temperature, taste or flavor of the target food, so as to improve the food shaping mold.

15. The method for manufacturing a food shaping mold of claim 2, further comprising a step of:
providing a sales analysis module, the sales analysis module analyzing a sales volume of the target food on a market to obtain preferences of consumers regarding a shape, density, hardness, glutenness, elasticity, tasting texture, temperature, taste or flavor of the target food, so as to improve the food shaping mold.

16. The food shaping mold of claim 3, comprising a mold base and a mold core, wherein the mold base is a fixed structure, or the mold core is a mobile structure or a replaceable structure.

17. The food shaping mold of claim 4, comprising a mold base and a mold core, wherein the mold base is a fixed structure, or the mold core is a mobile structure or a replaceable structure.

18. The food shaping mold of claim 5, comprising a mold base and a mold core, wherein the mold base is a fixed structure, or the mold core is a mobile structure or a replaceable structure.

19. The food shaping mold of claim 3, applying a pressure upon the target food once, a plurality of times or in stages, so that the target food has different densities, glutenness, hardness, elasticity, tasting textures, tastes or flavors at different positions.

20. The food shaping mold of claim 4, applying a pressure upon the target food once, a plurality of times or in stages, so that the target food has different densities, glutenness, hardness, elasticity, tasting textures, tastes or flavors at different positions.

21. The food shaping mold of claim 5, applying a pressure upon the target food once, a plurality of times or in stages, so that the target food has different densities, glutenness, hardness, elasticity, tasting textures, tastes or flavors at different positions.

22. The method for manufacturing a food shaping mold of claim 1, wherein a material or physical numerical values of materials of different ingredients of the target food are obtained, measured or calculated, the physical numerical values are input to a module for calculation to calculate a shape or form of a food shaping mold corresponding to a target shape or target structure of the target food or a corresponding food, so as to produce a shape, form or structure of the food shaping mold or the corresponding food.

23. The method for manufacturing a food shaping mold of claim 2, wherein a material or physical numerical values of materials of different ingredients of the target food are obtained, measured or calculated, the physical numerical values are input to a module for calculation to calculate a shape or form of a food shaping mold corresponding to a target shape or target structure of the target food or a corresponding food, so as to produce a shape, form or structure of the food shaping mold or the corresponding food.

24. A method for manufacturing a food, manufacturing a shape, form or structure of the target food by using the food shaping mold of claim 3.

25. A method for manufacturing a food, manufacturing a shape, form or structure of the target food by using the food shaping mold of claim 4.

26. A method for manufacturing a food, manufacturing a shape, form or structure of the target food by using the food shaping mold of claim 5.

27. A method for manufacturing a food shaping mold, comprising a step of:
providing a calculation module, the calculation module calculating a material, structure, shape or form of a corresponding food shaping mold according to a target density, hardness, elasticity, glutenness, tasting texture, taste, temperature or flavor of a target food so as to produce the food shaping mold.

28. A method for manufacturing a food shaping mold, comprising a step of:
providing a calculation scheme, the calculation scheme calculating a material, structure, shape or form of a corresponding food shaping mold according to a density, hardness, elasticity, glutenness, tasting texture, taste, temperature or flavor of a target region of a target food so as to produce the food shaping mold.
